(19) United States
(12) Patent Application Publication
(10) Pub. No.: US 2007/0273885 A1
(43) Pub. Date: Nov. 29, 2007

(54) Method and Device for Analysing Visual Properties of a Surface

(75) Inventors: Swie Lan Njo, Oegstgeest (NL); Ivo Bernardus Nicolaas Van Der Lans, Den Hoorn (NL)

Correspondence Address: KENYON & KENYON LLP, ONE BROADWAY, NEW YORK, NY, 10004, US

(73) Assignee: Akzo Nobel Coatings International B.V., BM Arnhem (NL)

(21) Appl. No.: 11/793,084

(22) PCT Filed: Dec. 13, 2005
(86) PCT No.: PCT/EP05/56760

§ 371 Date: Jun. 28, 2007

(30) Foreign Application Priority Data
Dec. 14, 2004 (EP) 04078382.1

(51) Int. Cl. G01N 21/47

(52) U.S. Cl. 356/446

(57) ABSTRACT

A method for imaging a sample by means of a device having a cavity with black inner walls and a sample opening, the device further comprising illumination means for illumination of the cavity and a digital imaging device directed from the cavity to the sample opening, the method comprising the following steps: presenting a sample to the cavity via a sample opening; illuminating the cavity; activating the imaging device to record an image of the sample; communicating the recorded image data to a computer programmed with image analysis software to analyze the recorded image, characterized in that the inner wall of the cavity is light absorbing and in that it is at least partly provided with light point sources distributed over at least a part of the inner wall of the cavity and a selection of the light sources, dependent on the desired light conditions, is activated.

### FIELD OF INVENTION

The invention relates to a method for imaging a sample by means of a device having a cavity with inner walls and a sample opening, the device further comprising illumination means for illumination of the cavity and a digital imaging device directed from the cavity to the sample opening, the method comprising the following steps: presenting a sample to the cavity via a sample opening; illuminating the cavity; activating the imaging device to record an image of the sample; communicating the recorded image data to a data processing unit programmed with image analysis software to analyze the recorded image. The invention also relates to a device for use in such method.

### BACKGROUND OF INVENTION

WO 99/042900 discloses a method and a device for imaging an object placed in an internally illuminated white-walled integrating sphere using a digital camera. The image is analyzed by a computer to generate colour data. The optical axis of the camera is aligned with the object to be measured. The white inner wall serves to guarantee a diffuse light distribution. It is not possible to examine the effects of variable light conditions.

Particularly when effect pigments such as aluminum flake pigments are used, the look of a paint film is not of a uniform colour, but shows non-uniformities such as coarseness, glints, micro-brilliance, cloudiness, mottle, speckle, sparkle or glitter. Some of these effects are dependent on the direction and distribution of light. In the following, texture is defined as the visible surface structure in the plane of the paint film depending on the size and organization of small constituent parts of the surface material. Coarseness is texture without the effects of glints and glitter. Hence, coarseness can be defined as the surface structure visible under the condition of diffuse light in the plane of the paint film depending on the size and organization of small constituent parts of the surface material. When light comes from each direction to the same extent, it is considered to be diffuse. Since glitters and glints are variations in gloss which are dependent on the angle between the observation direction and the illumination direction, glitters and glints do not occur under the condition of diffuse light. In this context, texture and coarseness do not include tactile surface roughness of the paint film but only the visual irregularities in the plane of the paint film.

Car paints often comprise effect pigments such as aluminium flake pigments to give a metallic effect. Also pearlescent flake pigments are often used. When a damaged car needs to be repaired, a repair paint must be used which not only has a matching colour but which also matches in terms of other visual characteristics, such as texture and coarseness.

Hitherto, the texture and the coarseness of surfaces, in particular paint films, have been judged by the eye, e.g., by comparing them with samples in a sample fan. The results of such an approach are highly dependent on the skills of the practitioner and often are not satisfying.

U.S. patent application US 2001/0036309 discloses a method of measuring micro-brilliance and using it for matching a repair paint with an original paint on, e.g., an automobile. The micro-brilliance is measured by imaging a part of the paint film with a CCD camera and by using image processing software to calculate micro-brilliance parameters.

WO 03/029766 discloses a colour measuring device, e.g. for paints, comprising an enclosure for receiving the object to be measured, lamps, and a digital camera. The inner surface of the enclosure can be coated with a matt paint to obtain diffused and uniform light. It further describes a method of measuring texture in such an enclosure and calculating a texture value. The lamps as well as the camera and the object to be measured are located in the enclosure.

When trying to find a repair paint formulation matching colour and texture an originally applied paint, there is a risk to find a repair paint formulation that may match under particular light conditions but that might mismatch under other light conditions. Hence, it is the object of the invention to provide a device and a method which allow analysis and characterization of texture effects in a way that can be used to formulate repair paints which match under various light conditions.

### SUMMARY OF INVENTION

The object of the invention is achieved with a method as described in the opening paragraph, characterized in that the inner wall of the cavity is light absorbing and in that at least part of the illumination means is formed by light point sources evenly distributed over at least a part of the inner wall of the cavity, and a selection of the light sources is activated dependent on the desired degree of directionality of light.

By switching on all light point sources diffuse conditions are generated, whereas by switching off all light point sources except one, directional lighting is obtained, due to the light-absorbing inner wall. The sample can be illuminated directionally from different angles by using a different light point source each time. Also mixtures of diffuse and directional illumination can be used.

### BRIEF DESCRIPTION OF DRAWINGS

FIG. 1 shows in cross-section an embodiment of a device according to the present invention.

FIG. 2 shows in cross-section an alternative embodiment of a device according to the present invention.

### DETAILED DESCRIPTION

To obtain sufficiently diffuse and intense light, the light point sources, e.g. Light Emitting Diodes, or LED's, should preferably be distributed equally, for instance over substantially the whole inner surface of the cavity. The light sources can for example be directed to the sample opening. In a suitable embodiment, 1 LED is present per 15-25 cm², preferably per 16-20 cm².

The light point sources can be located in the cavity itself or can illuminate the cavity via openings in the cavity wall.

The inner wall of the cavity can be made light absorbent for instance by painting it black.

In order to prevent the reflection of the camera in the sample from being recorded, the imaging device can be arranged outside the scope of its specular reflection. This is particularly useful if diffuse light conditions are created, e.g. when all light point sources are switched on.

Suitable imaging devices are for example digital photo or video cameras comprising a CCD or any other memory chip suitable for the storage of image data.

The digital record can be a colour image, but this is not necessary for analyzing texture effects. Black-and-white recordings can also be used.

The digital record is subsequently forwarded to a data processing unit loaded with image analysis software which can be used to translate the image into one or more texture parameters. Suitable image processing software is for instance Optimas® or Image ProPlus®, both commercially available from Media Cybernetics, MacScope®, available from Mitani Corporation, or Matlab®, available from The MathWorks Inc. The data processing unit can for instance be a computer or a chip, e.g., within the camera.

Analyzing and Characterizing Coarseness

In order to extract a texture parameter from a digital image, a set of representative car colours is collected and judged visually using a reference scale that covers the whole texture parameter range. An algorithm is derived that extracts texture parameter values from the images of the set of car colours that closely correlate to the visual assessments.

Coarseness data can be distracted from the digital recording using, e.g., statistical methods, filter-bank methods, structural methods and/or model based methods.

Starting from a CCD image of N×N pixels, the gray value standard deviation σ can be determined at several scales X: At the smallest scale X=1 it is calculated per individual pixel. At the second smallest scale it is calculated over the average gray values of squares of 2×2 pixels (X=4). At the third smallest scale squares of 4×4 pixels are used, so X=16. This is repeated up to the maximum scale of N×N pixels (X=N²).

The gray value standard deviation σ can be described as a function of the scale X, using:

$${σ}_{gray} = A + \frac{B}{{X}^{C}}$$

With σ_{gray} and X being known, parameters A, B, and C can be calculated by fitting.

The A, B, and C parameters can be correlated to a visual coarseness value by:
Coarseness=α₁+α₂A+α₃B+α₄C

The values for the α₁, α₂, α₃, and α₄ have been pre-determined beforehand by comparison with a set of panels of representative car colours. These reference colours are judged by the eye and accorded a value according to a reference scale. This is done by a number of people and the accorded values are averaged per panel. For each of these reference colours, the measured VC should be equal to the value according to the reference scale for visual judgment. The parameters α₁, α₂, α₃, and α₄ are found by minimizing the difference between the observed and the measured values for all used panels in the set of representative car colours. To find equal values for the α₁, α₂, α₃, and α₄ parameters for all panels of the set of representative car colours, the square value of the difference between the reference scale value and the visual coarseness value VC is calculated for each panel. The sum of all these square values Σ_{all panels} (visual judgment_{panel i}−VC_{panel i})² is subsequently minimized, resulting in values for α₁, α₂, α₃, and α₄. With these parameters being known, the coarseness of any car paint film can be determined.

In an alternative way to calculate coarseness, the mean gray value (m) and the standard deviation (σ) are determined of all pixels of the image. Coarseness is then expressed as follows:

$$Coarseness = {α}_{1} + {α}_{2} \frac{σ}{m}$$

The parameters α₁ and α₂ are found by minimizing Σ_{all panels} (average visual judgment_{panel i}−Coarseness_{panel i})² using the set of representative car colours. When α₁ and α₂ are known, the coarseness of any colour can be determined. Instead of gray values, the R, G and/or B values can also be used.

In a structural method to calculate coarseness, the image is segmented in subsets of neighbouring pixels that stand out. A threshold is defined, 10 times the mean value (m) of the image, to distinguish segments from the background. Segments can have a maximum size of 2.5% of the total amount of pixels in the image and should be 8-connected. Also other segmentation method might be used. The number of segments (n) is calculated and the mean value of a segment (ms). The coarseness is then calculated as follows:
Coarseness=α₁+α₂ ln n+α₃ ln ms+α₄ ln m

As above, the parameters α₁, α₂, α₃ and α₄ are found by minimizing Σ_{all panels} (average visual judgment_{panel i}−Coarseness_{panel i})² using the set of representative car colours. When α₁, α₂, α₃ and α₄ are known, the coarseness of any colour can be determined.

The effect of coarseness is mainly caused by the larger optical non-uniformities. Smaller non-uniformities hardly contribute to coarseness. A filter-bank method can be used to filter out the smaller non-uniformities. To this end, the image is first transformed to the Fourier domain. Then a filter is applied to select and filter out certain frequency areas. Subsequently, the image is backtransformed and the mean value (m) and standard deviation (σ) are extracted. As above, the coarseness is calculated as follows:

$$Coarseness = {α}_{1} + {α}_{2} \frac{σ}{m}$$

The parameters α₁ and α₂ are found by minimizing Σ_{all panels} (average visual judgment_{panel i}−Coarseness_{panel i})² using the set of representative car colours. When α₁ and α₂ are known, the coarseness of any colour can be determined.

Analyzing and Characterizing Glints

The parameter “glints” is another texture parameter which describes the perception of bright tiny light spots on the surface of an effect coating under directional illumination conditions that switch on and off when the viewing angle is changed. Glints are best observed in direct sunlight, i.e. with a cloudless sky, from less than one meter. Even when the observation conditions are the same, some effect coatings show many bright glints, whereas other effect coatings show few or even no glints at all. A glint scale has been designed with which an observer can visually inspect the effect coating and express the glints aspect as a number. Some effect coatings will have a low glints value, others a high glints value. This way, the texture aspect “glints” of a coating can be observed quantitatively. The glints effect is generally determined at several viewing angles.

Glints can be extracted using information from an image of a directionally illuminated sample or from two images of a sample that is first illuminated directionally and then diffusely or vice versa. From the image captured with diffuse illumination the average gray value is calculated and called the background gray value. From the image acquired under directional conditions glints properties are extracted using a three-stage approach: first bright pixels are singled out by setting a threshold which is defined as the average gray value of the selected pixels divided by the gray value of the original image. This value should not exceed a predefined limit. A suitable value is for instance 1.7. Then selected pixel areas that are smaller than 3×3 pixels are removed. Finally we test whether a glint stands out: its brightness (area size multiplied by gray value) should be larger than Y times the gray value of the original image. Y is typically chosen to be 20. Subsequently the total glint gray value and the average glint size are abstracted. If only the directionally illuminated image is used to obtain glints, also the average gray value of all pixels not belonging to the glints is calculated and called background gray value. Parameters β₁, β₂, and β₃ of the following model are calibrated against visual assessments done with a reference swatch on a set of representative car colours.

$$Glints = {β}_{1} + {β}_{2} ln \frac{( total glint gray value )}{( background gray value )} + {β}_{3} ln ( average glints size )$$

When β₁, β₂ and ⊖₃ are known, the glints of any colour can be determined.

To calculate glints at a specific illumination angle, additional information can be used extracted from images taken at a set of other, different illumination angles. Best results are obtained if images are selected that have been taken at illumination angles that differ not too much from the illumination angle to be calculated, e.g., about 15 degrees or less. From all images the mean value (m) and the standard deviation (σ) are determined. The glints value is then calculated as follows:

$$Glints = {β}_{1} + {β}_{2} \frac{{σ}_{1}}{{m}_{1}} + {β}_{3} \frac{{σ}_{2}}{{m}_{2}} + {β}_{4} \frac{{σ}_{3}}{{m}_{3}} + {σ}_{1} + {m}_{1}$$

The parameters β₁, β₂, β₃ and β₄ are found by minimizing Σ_{all panels} (average visual judgment_{panel i}−Glints_{panel i})² using the set of representative car colours. When β₁, β₂, β₃ and β₄ are known, the glints of any colour can be determined.

In a further alternative way to calculate glints, the median value (m) and the skew (σ³) can be determined of an image. A value t can be determined by ranking all pixels from high to low gray value: if the highest ranked x percent of these ordered pixels are taken, then t is lowest gray value of the selected pixels. The glints value can then be expressed according to the following formula:
Glints=β₁+β₂\sqrt{m₁}+β₃\sqrt{σ}+β₄\sqrt{t}

The parameters β₁, β₂, β₃ and β₄ are found by minimizing Σ_{all panels} (average visual judgment_{panel i}−Glints_{panel i})² using the set of representative car colours. When β₁, β₂, β₃ and β₄ are known, the glints of any colour can be determined.

In again another method to calculate glints, the image is segmented into subsets of neighbouring pixels that stand out in color. Subsequently their number (n) and size (s) are calculated and their deviation from the background (d=color glints/color background).
Glints=β₁Σβᵢnᵢ+Σβᵢsᵢ+Σβᵢ+Σβᵢdᵢ

The parameters βᵢ are found by minimizing Σ_{all panels} (average visual judgment_{panel i}−Glints_{panel i})² using the set of representative car colours. When the βᵢ are known, the glints of any colour can be determined.

A further alternative way to measure texture, in particular so-called micro-brilliance, with a digital imaging device and image analysis software is disclosed in US 2001/0036309, incorporated herein by reference.

The invention is particularly useful in examining automotive paints and in finding matching repair paints, e.g., for cars or other products to be repaired.

The invention will further be explained by reference to of the following figures.

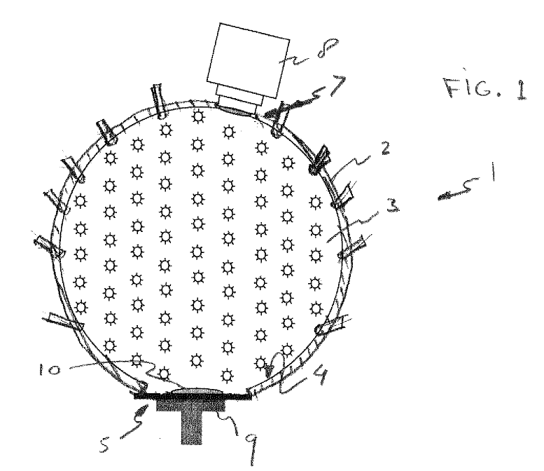

FIG. 1 shows a device 1 having a spherical casing 2 enclosing a spherical cavity 3 with an inner wall 4 and a sample opening 5. A large number of light emitting diodes, LED's, 6 are distributed equally over the inner wall 4 for illumination of the cavity 3. Via a second opening 7 a digital imaging device 8 is directed to the sample opening 5. A sample table 9 closes off the sample opening 5. A sample 10 is placed on the sample table 9 and presented to the inner cavity 3 of the device 1. The sample 10 can for instance be coated with a paint film. The inner cavity can be illuminated by activating the LED's 6 via a control panel (not shown). The LED's 6 can be activated groupwise or all together. If so desired, they may also be activated individually. If they are activated all together, the light distribution within the cavity 3 is substantially uniform and diffuse light conditions are obtained. If only one group of adjacent LED's 6 is activated, the light conditions are not diffuse but directional. Under such directional light conditions samples coated with effect paints show gonio-dependent optical effects, such as glints. Depending on the selection of activated LED's, the light conditions can be varied gradually from diffuse, semi-diffuse, and semi-directional up to the situation where the sample is illuminated by only a single LED, which would be the most directional light condition of all.

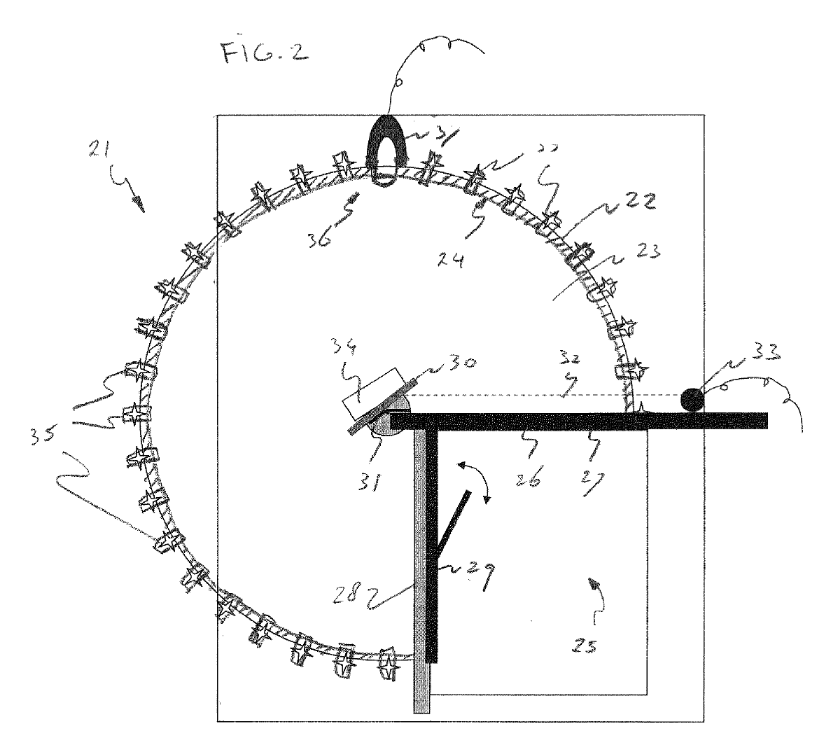

FIG. 2 shows an alternative embodiment. This embodiment includes a device 21, shown in cross-section, with a substantially spherical casing 22 enclosing a spherical cavity 23 with an inner wall 24. One quarter of the sphere is cut out to provide an opening 25. Via this opening 25, the device 21 is put over the edge of a table 26 made of a horizontal panel 27 and a vertical support panel 28, jointly closing off the opening 25. The vertical panel 28 is provided with a shutter panel 29 allowing access to the cavity 23. On the edge of the table 26, a tilting plate 30 is mounted by means of a hinge 31. Via a cable 32 the tilting plate 30 is linked to driving means 33, located outside the cavity 23. This way the driving means 33 can rotate the tilting plate 30 between a horizontal position and a vertical position. When the tilting plate 30 hangs in the vertical position, the user can attach a sample 34 to it via shutter panel 29. After that, the driving means 33 can rotate the tilting plate 30 with the sample 34 to the desired position. A large number of light emitting diodes, LED's, 35 are distributed equally over the inner wall 24 for illumination of the cavity 23. Via a second opening 36 a digital imaging device 37 is directed to the sample opening 25. A sample 10 is placed on the sample table 9 and presented to the inner cavity 3 of the device 1. The sample 10 can for instance be coated with a paint film. The inner cavity 23 can be illuminated by activating the LED's 35 via a control panel (not shown). The LED's 35 can be activated groupwise or all together. If so desired, they may also be activated individually. If they are activated all together, the light distribution within the cavity 23 is substantially uniform and diffuse light conditions are obtained. If only one group of adjacent LED's 35 is activated, the light conditions are not diffuse but directional. Under such directional light conditions samples coated with effect paints show gonio-dependent optical effects, such as glints. Depending on the selection of activated LED's 35, the light conditions can be varied gradually from diffuse, semi-diffuse, and semi-directional up to the situation where the sample is illuminated by only a single LED 35, which would be the most directional light condition of all.

1-5. (canceled)

6. A device for imaging a sample, the device comprising:
a cavity with an inner wall and a sample opening;
light point sources distributed over at least a part of the inner wall of the cavity;
a digital imaging device directed from the cavity to the sample opening; and
a control panel for controlling a variable selection of the light point sources;
wherein the light point sources are activatable dependent upon a desired degree of directionality of light, and wherein the inner wall of the cavity is light absorbent.

7. The device according to claim 6, wherein the light point sources are light emitting diodes.

8. The device according to claim 7, wherein the inner wall of the cavity is black.

9. The device according to claim 6, wherein the light point sources are distributed equally over substantially the entire inner wall of the cavity.

10. The device according to claim 7, wherein the light emitting diodes are distributed equally over substantially the entire inner wall of the cavity.

11. The device according to claim 10, wherein the light emitting diodes are distributed such that one light emitting diode is present per 15-25 cm² of the inner wall.

12. The device according to claim 10, wherein the light emitting diodes are distributed such that one light emitting diode is present per 16-20 cm² of the inner wall.

13. The device according to claim 10, wherein the inner wall of the cavity is black.

14. The device according to claim 6, wherein the digital imaging device is arranged outside the scope of its specular reflection.

15. The device according to claim 7, wherein the digital imaging device is arranged outside the scope of its specular reflection.

16. The device according to claim 8, wherein the digital imaging device is arranged outside the scope of its specular reflection.

17. The device according to claim 9, wherein the digital imaging device is arranged outside the scope of its specular reflection.

18. The device according to claim 10, wherein the digital imaging device is arranged outside the scope of its specular reflection.

19. The device according to claim 11, wherein the digital imaging device is arranged outside the scope of its specular reflection.

20. The device according to claim 12, wherein the digital imaging device is arranged outside the scope of its specular reflection.

21. The device according to claim 13, wherein the digital imaging device is arranged outside the scope of its specular reflection.

22. A method for imaging a sample, the method comprising:
presenting a sample to a device, the device comprising a cavity with a light-absorbing inner wall and a sample opening, an illumination means for illumination of the cavity, and a digital imaging device directed from the cavity to the sample opening, wherein the sample is presented to the cavity via the sample opening;
illuminating the cavity with the illumination means, wherein at least a part of the illumination means includes light point sources evenly distributed over at least a part of the inner wall of the cavity, and wherein a selection of the light point sources is activated dependent upon a desired degree of directionality of light;
activating the digital imaging device to record an image of the sample; and
communicating the recorded image of the sample to a data processing unit programmed with image analysis software to analyze the recorded image of the sample.

23. The method according to claim 22, wherein the light point sources are light emitting diodes.

24. The method according to claim 23, wherein the inner wall of the cavity is black.

25. The method according to claim 22, wherein the digital imaging device is arranged outside the scope of its specular reflection.
